(19) United States
(12) Patent Application Publication
(10) Pub. No.: US 2017/0039813 A1
(43) Pub. Date: Feb. 9, 2017

(54) MULTI-HAND POKER WAGERING GAME

(71) Applicants: TRAVIS WADE WALTERS, LAS VEGAS, NV (US); RUSSELL BROOKE DUNN, HENDERSON, NV (US)

(72) Inventors: TRAVIS WADE WALTERS, LAS VEGAS, NV (US); RUSSELL BROOKE DUNN, HENDERSON, NV (US)

(21) Appl. No.: 15/225,893

(22) Filed: Aug. 2, 2016

Related U.S. Application Data
(60) Provisional application No. 62/200,227, filed on Aug. 3, 2015.
(60) Provisional application No. 62/200,117, filed on Aug. 3, 2015.

(51) Int. Cl. G07F 17/32; A63F 1/14; A63F 1/00; A63F 1/12

(52) U.S. Cl. CPC G07F 17/3293; A63F 1/12; A63F 1/14; A63F 1/00; G07F 17/3244; G07F 17/3276; A63F 2001/005

(57) ABSTRACT

A wagering playing card game provides a player with two hands of equal cards. A player may discard one or more cards in a first hand and share parallel cards in the second hand between the first and second hands. Separate ante wagers and play wagers are placed on each hand to keep them in play.

### RELATED APPLICATION DATA

This Application claims priority from U.S. Provisional Patent Application Ser. No. 62/200,227, filed 3 Aug. 2015 titled MULTI-HAND POKER WAGERING GAME.

### BACKGROUND OF THE INVENTION

1. Field of the Invention

The present invention relates to the field of gaming technology, engaging in poker wagering events and engaging in multiple poker wagering events at a single player position in a single event.

2. Background of the Art

In casinos, game rooms, card rooms and on-line wagering, there are features that tend to define a successful game, even those these features are hard to combine. Some of these features include: a) simplicity of the game, so that new players are quickly comfortable with the game; b) speed of play with few complex decisions; c) similarity to known games; d) frequency of winning outcomes; and e) sufficient casino profit to warrant dedication of floor space to the gaming event.

Ways of increasing sufficient casino profits include increasing minimum wagers, adding wagers during play, providing side bet events and increasing numbers of game events (e.g., hands) during the wagering event. The ability to provide multiple hands during a gaming event is generally a good way to increase profits without reducing frequency of player winning outcomes or reducing odds on payouts.

Among successful table games and video gaming events are those listed below.

U.S. Pat. No. 5,732,950 (Moody) involves dealing multiple rows of five card hands. The player attempts to achieve a high ranking poker hand on the center row by using face up and face down cards as potential replacement cards for the five cards initially dealt to the center row. An alternate method involves permitting the player to play up to three hands of video poker at the same time.

U.S. Pat. No. 6,012,720 (Webb) discloses Double Hand card games that provide a Double Hand wager with a Copy Hand wager. Each player places a basic Double Hand wager and an optional Copy Hand wager before the cards are dealt. Six cards are dealt to each player with dealer also receiving six cards. Each player and the dealer use Wild Indicia (e.g., a promotional card, a Joker, or an implicit card) to form the best possible five-card high hand (High Hand) and two-card low hand (Low Hand). The High and Low Hands of each player are then compared with the respective High and Low Hands of the dealer and the Double Hand and Copy Hand wagers are settled.

U.S. Pat. No. 6,474,646 (Webb) enables a card game in which each player and the dealer are dealt five cards to form two two-card hands and one one-card hand, corresponding to a HIGH hand, a MID hand, and a LOW hand. The player HIGH, MID and LOW hands are compared with the respective dealer hands to determine a game result. In one operating mode, players can make a wager for each of the three hands, and the wagers are paid or taken separately depending on the respective comparison results. Alternatively, players may make a single wager that wins if the player wins at least two out of the three hands. The game also includes provisions for proposition wagers such as a copy wager and/or a pair wager as well as an empty hand or Dragon Hand concept.

U.S. Pat. No. 5,685,774 describes card-type games that provide at least one player with the option of wagering against either a predetermined payout schedule or a dealer's hand, or both. According to another aspect, each player is provided with a wild card which is retained and used repeatedly by a player in each hand. The wild card may take a novel promotional form and is preferably more durable than the standard playing cards.

### SUMMARY OF THE INVENTION

A method of playing a playing card wagering game against a paytable and a dealer position hand, the playing card game including steps of:
a) a player position receiving two distinct wagers at each of two ante positions at the player position;
b) providing two distinct hands of an equal number of random playing cards, one hand each at each of the two ante positions comprising a first hand and a second hand, the first hand being immediately viewable upon its being provided at the player position, and the second hand (or subsequent hand(s), such as third, fourth and fifth hands, etc. if more than two hands are provided and are to be played against a dealer hand) not being immediately viewable upon delivery and the first hand and second hand being received as distinct sets of the equal number of cards (cards are preferably dealt from a single set or deck of playing cards, with or without a joker, but multiple decks or individual decks for each position in an electronic version may be used to provide unique potentials for hand ranks);
c) providing a dealer position hand of random playing cards having a number of random cards at least equal to the equal number of random playing cards in the first hand;
d) receiving a second wager at a second bet position at the first hand position to continue play of the playing card wagering game with the first hand, or ending play of the first hand by the dealer position collecting the wager at the ante position for the first hand;
e) absolutely indicating in a first hand in which play is to be continued which if any playing cards are to be replaced, while leaving all playing cards in the first hand exposed to view and leaving all cards in an ordered position at the player position;
f) revealing all playing cards in the second hand while each card in the second hand is in alignment with a specific playing card in the revealed first hand; (This step would be repeated if there were more than just two player hands provided)
g) receiving a second wager at a second bet position at the second hand position to continue play of the playing card wagering game with the second hand, or ending play of the second hand by the dealer position collecting the wager at the ante position for the second hand;
h) revealing the playing cards of the dealer position hand;
i) reading final poker rank of the two player hands as follows:
   A) the second hand rank is read as including all playing cards in the second hand according to standard poker rankings for the number of playing cards in the second hand;
   B) the first hand rank is read by including only cards that have not been absolutely indicated as a card to be replaced, and then reading as a replacement card for each card indicated as replaced an aligned playing card from the second player hand, rank of the first hand according to standard poker rankings for the number of playing cards in the second hand; and
j) resolving all wagers at the first hand and the second hand by comparing ranks of the first hand and second hand against rank of the dealer hand and at least one of the first wager and the second wager for each of ranks of the first hand and the second hand against a paytable for poker hand ranks.

### BRIEF DESCRIPTION OF THE FIGURES

FIG. 1 shows an electronic gaming table on which the gaming method may be executed.

FIG. 1A shows a schematic for an electronic system for enabling play of the gaming method described herein.

FIG. 1B shows another schematic for an electronic system for enabling play of the gaming method described herein.

FIG. 2A shows a Double Deal (TM) player layout for a Three-Card Poker(TM) game variant.

FIG. 2B-FIG. 2G shows a sequence of player hand events in a single wagering event outcome.

FIG. 2H-FIG. 2M shows a sequence of player hand events in a second single wagering event outcome.

FIG. 2N-FIG. 2O shows a sequence of player hand events in a third single wagering event outcome in which no individual playing cards in a player first hand are moved into a second player hand for play.

### DETAILED DESCRIPTION OF THE INVENTION

A method and apparatus for playing a playing card wagering game against a paytable and a dealer position hand. The playing card game may be played in a number of sequences within the generic scope of the invention. The playing card game includes steps of:
a) a player position receiving (at least) two distinct wagers at each of two ante positions at the player position;

The two wagers should be equal, but it is contemplated that one wager may be a different value than the other. In particular, the wager on the second hand may be required to be larger than the wager on the first hand. The size of the wagers may be reversed, but as will be evident from later descriptions, it is easier to develop higher poker ranked hands in the second hand, so higher wagers on the first hand (with equal paytables between first and second hands) would favor the player and be disadvantageous to the house or casino or bank. Importantly, even more than two hands, and more than two wagers (one wager on each hand) may be engaged at a single player position. Three (four, five, six, etc., especially higher numbers in an electronic wagering system, up to the limit of available cards) separate hands may be dealt at each player position. The hands should be provided from a single set of playing cards, with the set being first randomized or playing cards randomly selected from the set. One mode of play is for hands to be dealt to the player position from a single deck of playing cards. The event may be practiced with a single deck dedicated to each player position, so that multiple decks (especially in an electronic mode) may be used for providing each player hand. The dealer position hand (if any) may come from the same or further separate deck.
b) providing (at least two) two distinct hands of an equal number of random playing cards, one hand each at each of the (at least) two ante positions comprising a first hand and a second hand, the first hand being immediately viewable upon its being provided at the player position, and the second hand not being immediately viewable upon delivery and the first hand and second hand being received as distinct sets of the equal number of cards;

The two hands (and the dealer hand) may be one-, two-, three-, four-, five-, six- or seven-card hands. The hands may be read as standard be two-, three-, four-, five-, six- or seven-card hands are read in poker games, although 5-card hands and 6-card hands may be read to find highest four-card poker hand ranks, and 6-card hands and 7-card hands may be read as best-of-five playing cards for a 5-card poker hand. The first hand may be placed face up or the player may turn the cards face up. The cards in the first hand may be dealt into a particular alignment or the player may be allowed to align the cards in an order desired by the player. Aligning the cards offers no discernible advantage, but allows a player to feel an ability to exercise some control in play of the game.
c) providing a dealer position hand of random playing cards having a number of random cards at least equal to the equal number of random playing cards in the first hand;

The dealer hand must have at least the same number of playing cards as the first hand and second hand at the player position. The dealer hand may have one more card or even two more cards than the player individual hands.
d) receiving a second wager at a second bet position at the first hand position to continue play of the playing card wagering game with the first hand, or ending play of the first hand by the dealer position collecting the wager at the ante position for the first hand;

The second wager may be required to be equal to the first wager, less than the first wager, or a limited multiple (1×, 2× or 3×) the first wager. The first wager may be played against either or both of i) a poker rank competition between dealer hand and the individual player hands and ii) a paytable of odds against poker ranks achieved in individual player hands. Payouts against the paytable may or may not require an individual player hand to beat the dealer hand for the paytable to be considered in resolution of either wager. The gaming event will be generally discussed as a two-hand event, evidencing an at least two-hand event, but with the understanding that more hands would be played equivalently, with similar events determined in each hand in similar manners.
e) absolutely indicating in a first hand in which play is to be continued in which if any playing cards are to be replaced, while leaving all playing cards in the first hand exposed to view and leaving all cards in an ordered position at the player position; an alternative step is for cards to be carried (in parallel) to the second hand are distinctly indicated (or distinctly indicating the cards to not be carried into the second hand). In this instance, the first hand is played as dealt in the underlying card game, but quality cards are passed (in parallel positions) to the second hand;

The playing cards selected for replacement (or the cards that are to be transferred or not transferred to parallel aligned positions in a second hand) must be indicated in a definitive and irreversible manner to have been removed from consideration in resolutions of rank or wagers for the first hand. This can be done, keeping the playing cards in an aligned order, by turning one or more playing cards face-down, turning one or more playing cards sideways, or by placing a marker over the playing cards to be replaced.
f) revealing all playing cards in the second hand while each card in the second hand is in alignment with a specific playing card in the revealed first hand;

The playing cards must be revealed in an ordered array, paralleling the order or array of the first hand. The cards must be positioned before revelation of the suit and rank of the cards in the second hand. The cards of the second hand may be revealed in any order as their physical relationship to cards to be replaced is fixed in advance of knowledge of rank and suit by placement into a fixed order or array with respect to the fixed order or array of the playing cards in the first hand, including the position of playing cards to be replaced.
g) receiving a second wager at a second bet position at the second hand position to continue play of the playing card wagering game with the second hand, or ending play of the second hand by the dealer position collecting the wager at the ante position for the second hand;

The second wager at the second position may again be equal to the first wager, less than the first wager, or a limited multiple (1×, 2× or 3×) the first wager. This is true also if there is a third, fourth, etc. additional wager on additional hands, if desired.
h) revealing the playing cards of the dealer position hand;

The playing cards in the dealer hand may be turned over in any order, as best poker hand ranks are read without respect to order of playing cards.
i) reading final poker rank of the two player hands as follows:
   A) the second hand rank is read as including all playing cards in the second hand according to standard poker rankings for the number of playing cards in the second hand;
   B) the first hand rank is read by including only cards that have not been absolutely indicated as a card to be replaced, and then reading as a replacement card for each card indicated as replaced an aligned playing card from the second player hand, rank of the first hand according to standard poker rankings for the number of playing cards in the second hand;

ii) alternatively, when the first hand is played with all its original cards and designated cards are passed into a second hand, reading final poker rank of the two player hands as follows:
C) the first hand rank is read using all original playing cards dealt to the first hand, even is cards are indicated as being passed into the second hand; and
D) the second hand rank is read by including cards that have been absolutely indicated as being transferred from the first hand into the second hand and the playing card(s) dealt into the second hand that parallel playing cards in the first hand that were absolutely indicated as not being transferred into the second hand from the first hand.

A review of FIG. 3 showing the play of card games will be of assistance in understanding the simplicity of the play of this gaming technology.
j) resolving all wagers at the first hand and the second hand by comparing ranks of the first hand and second hand against rank of the dealer hand and at least one of the first wager and the second wager for each of ranks of the first hand and the second hand against a paytable for poker hand ranks.

The bet resolutions are made in accordance with the rules of poker in competitive hands, and against paytables based on ranks of hands as compared to ranks in paytables. All hands may be resolved against a paytable.

As previously noted, the set of playing cards may be one or more (e.g., multiple) sets of standard decks of 52 playing cards, even with one or two additional jokers (total or for each deck). The method may have the completed player hand consisting of exactly three, four or five random playing cards.

The term “randomized cards” is more generic than literal usage of the term might indicate, mainly because of the nature of apparatus and methods for providing random cards or random hands. Some shuffling or randomization machines, for example, take a full set of playing cards are randomly select individual cards therein for “dealing” (e.g., a random ejection shuffler). Other shuffling devices physically distribute cards within compartments (either randomly or with known suit and rank of cards in each compartment). Random compartments or compartments randomly selected or random cards in compartments are then provided to a delivery tray. All of these variations are included within the scope of randomized cards, even though (especially with the random ejection shuffler) the set of cards are not randomized before provision of individual random cards. In a virtual system, a random number generator or templates of cards in each hand that is stored in memory may be used.

A system for providing a wagering event with playing cards for the method described above may include:
i. a gaming table with a playing surface providing markings on the playing surface identifying player position;
ii. the gaming table playing surface identifying positions at multiple player positions for the first game wager, the second wager and the play wager;
iii. a source of random playing cards on the gaming table;
iv. markings on the playing surface identifying player position; and

a display identifying odds resolving the second wager. The present technology may be varied without exceeding limits on the practice of the present technology. Payout rates and odds may be varied even beyond the examples given above.

The method may be practiced wherein playing card symbols are provided by provision of random physical playing cards provided from a randomized source of physical playing cards, and the physical playing cards are placed one-at-a-time from the source of physical playing cards to respective player hand position and banker hand position.

A system enabling the method may include a player table with indicia marking a player hand position and a dealer position, indicia marking a wagering position for a player hand winning outcome, a dealer hand winning outcome, a tie outcome, and a source of random physical playing cards from which playing card symbols are provided to each of the player hand and the banker hand.

A system enabling the method may include an electronic gaming machine comprising a housing, a video display, a processor, player table with indicia marking a player hand position and a banker position, indicia marking a wagering position for a player hand winning outcome, a banker hand winning outcome a tie outcome, and a source of random physical playing cards from which playing card symbols are provided to each of the player hand and the banker hand.

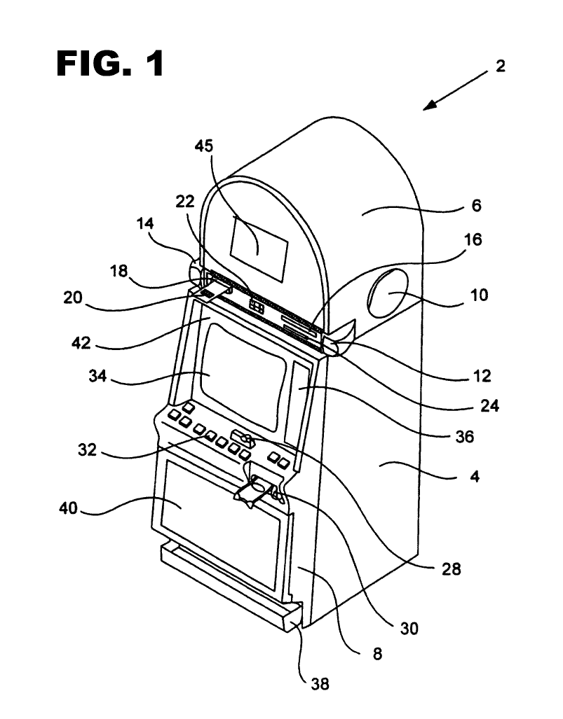

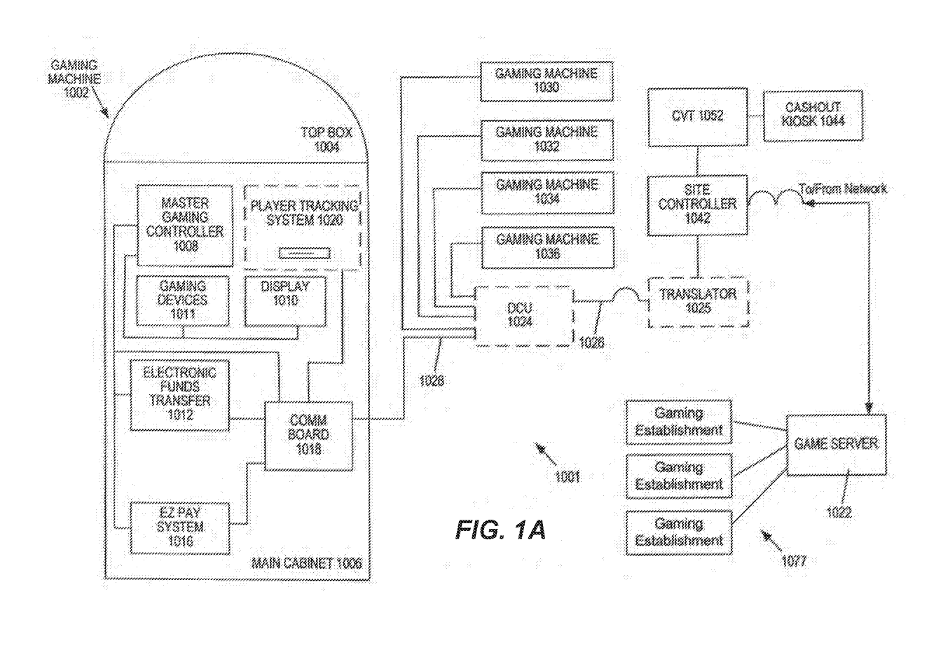

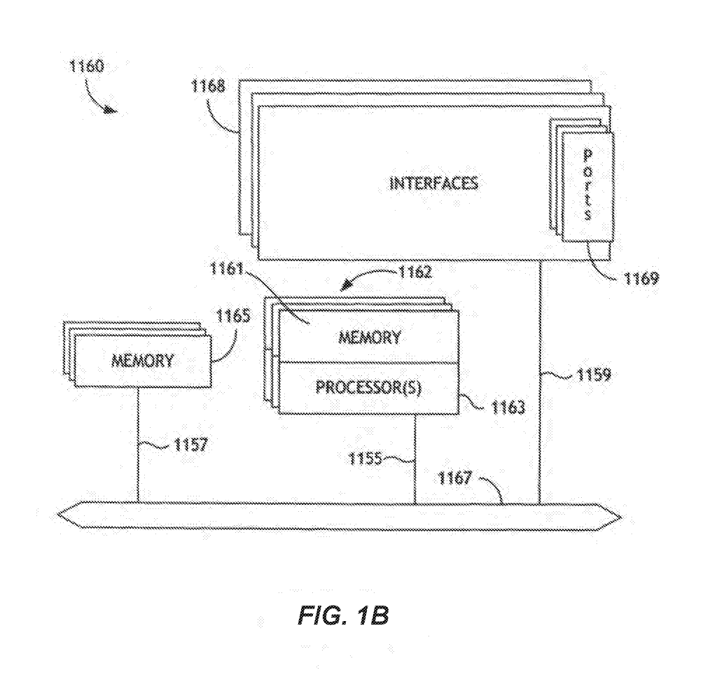

Turning next to FIG. 1, a video gaming machine 2 that may be used as the underlying base gaming counsel of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video blackjack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaining machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display-mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would retum to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog tinier circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during andlor after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering, information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

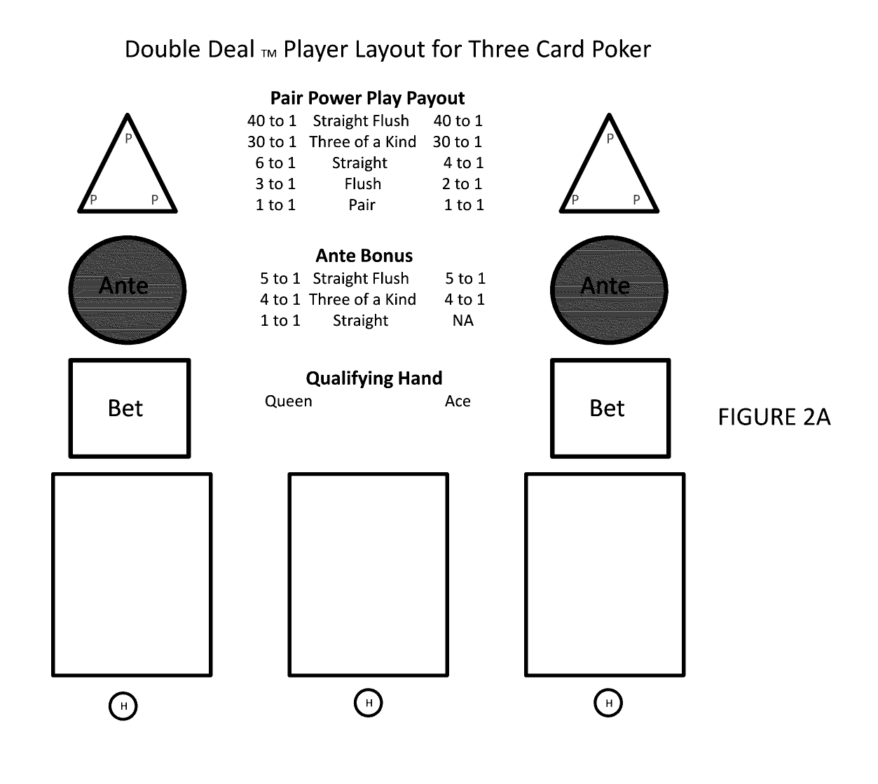

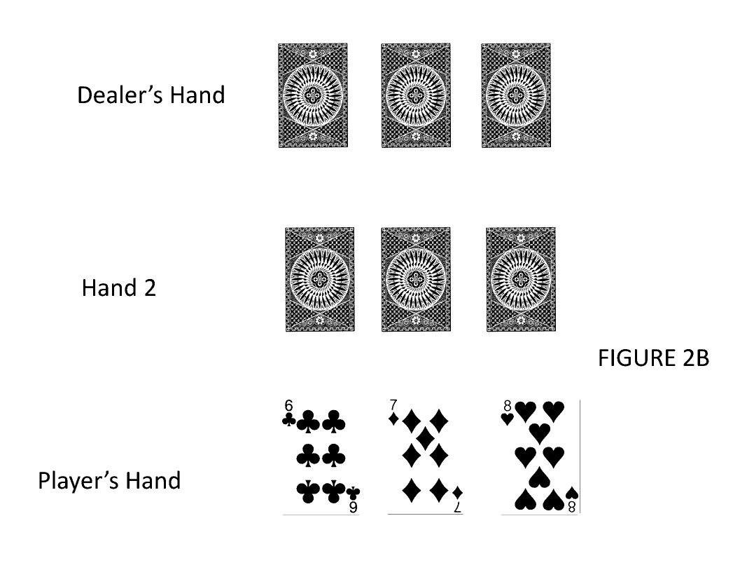

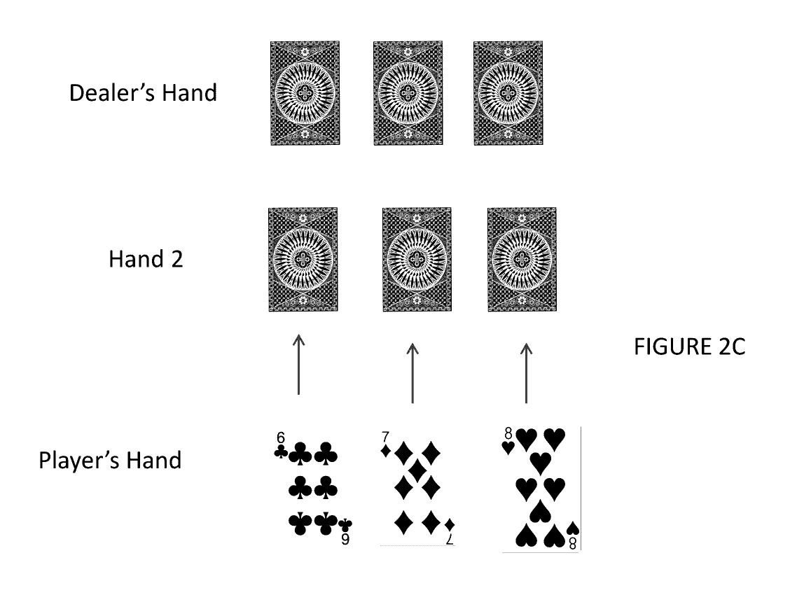

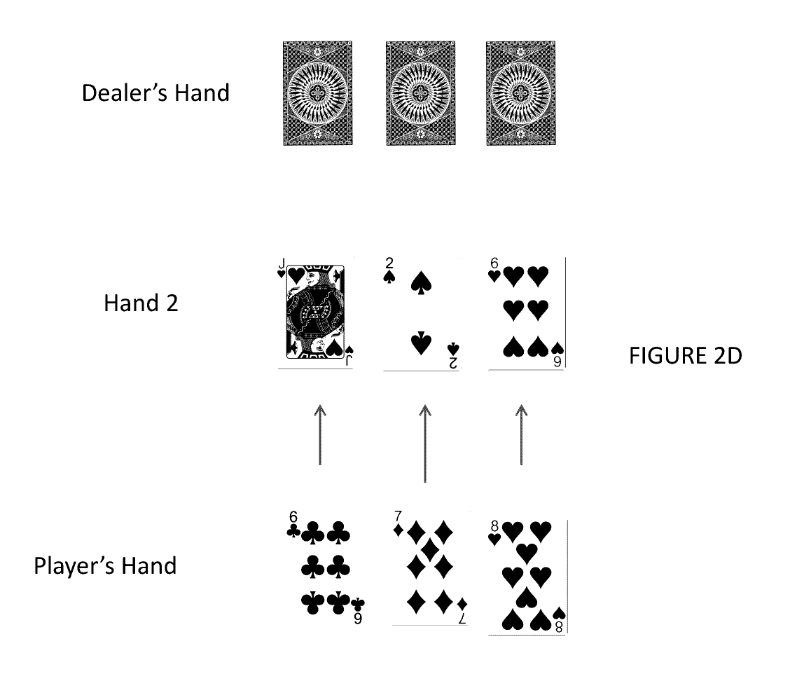

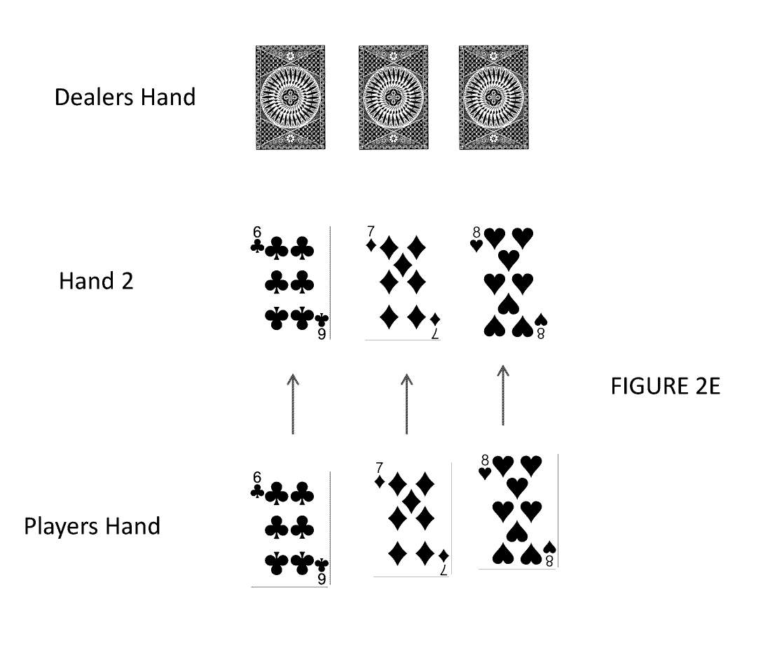

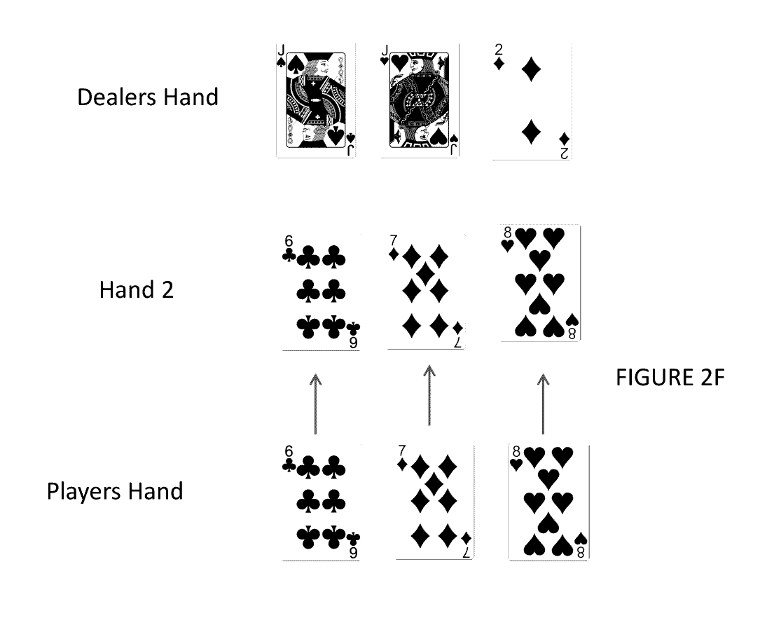

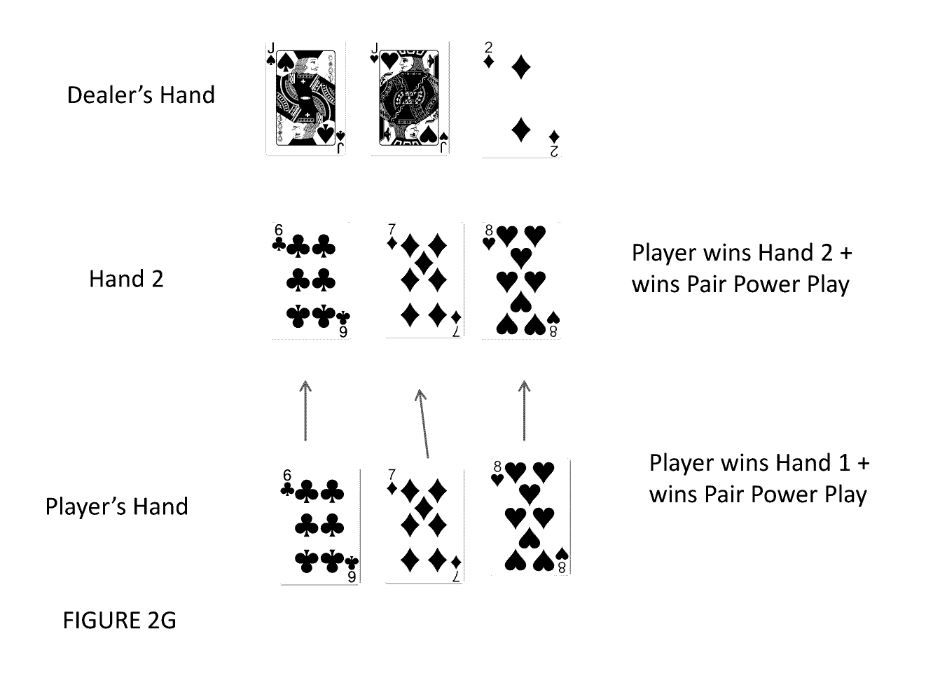

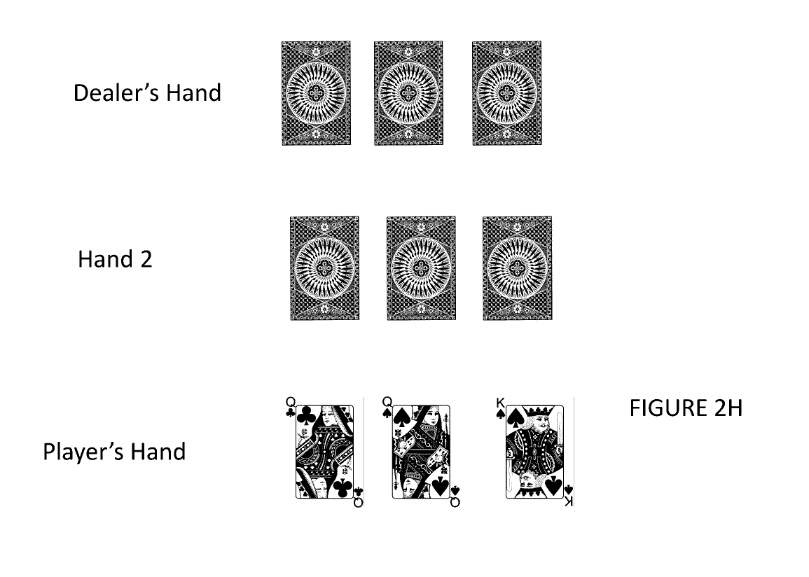

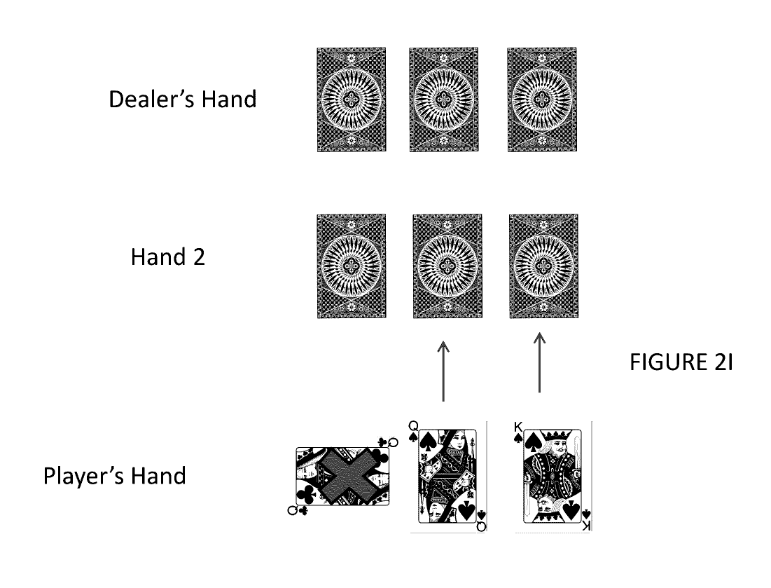

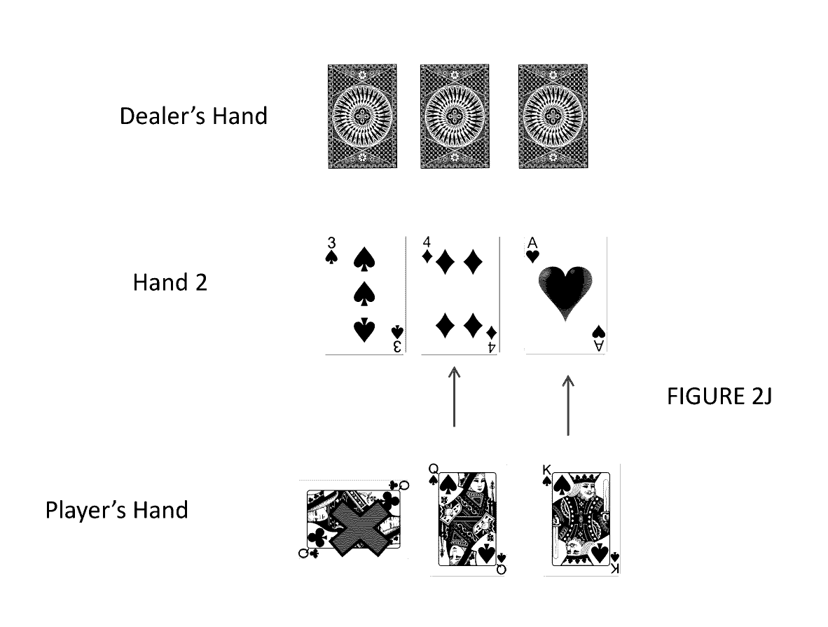

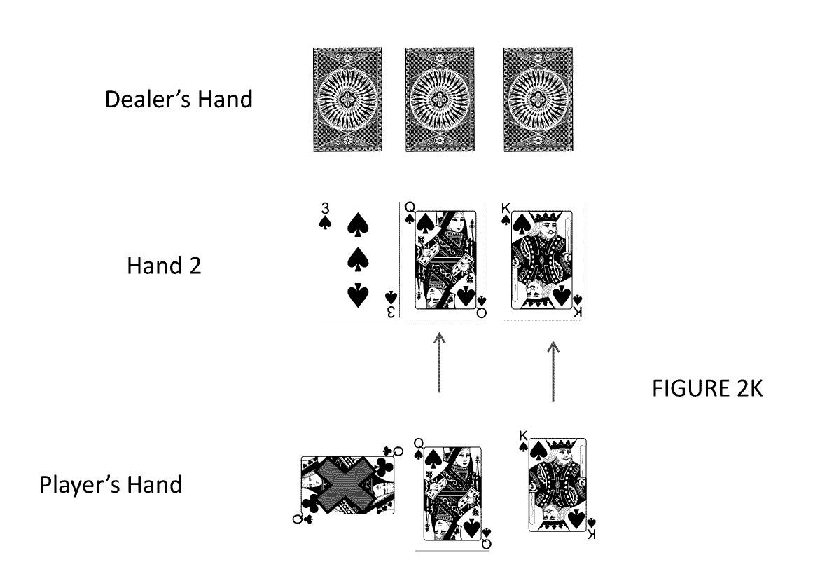

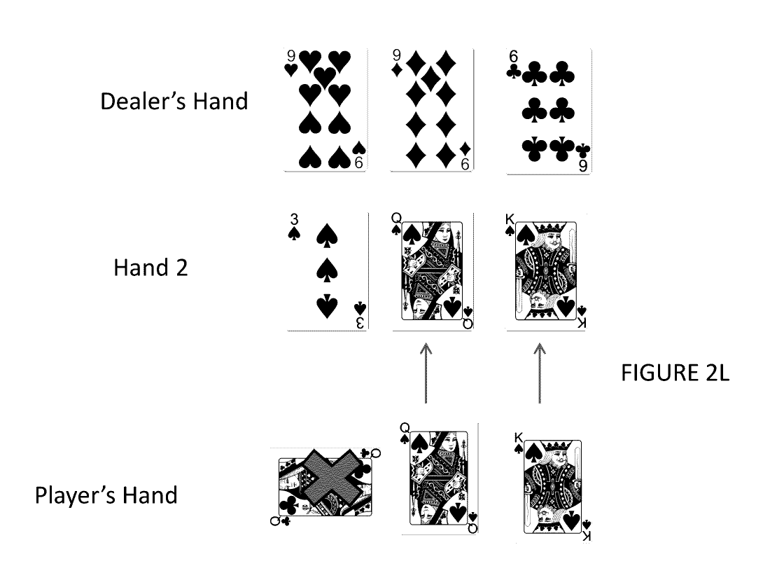

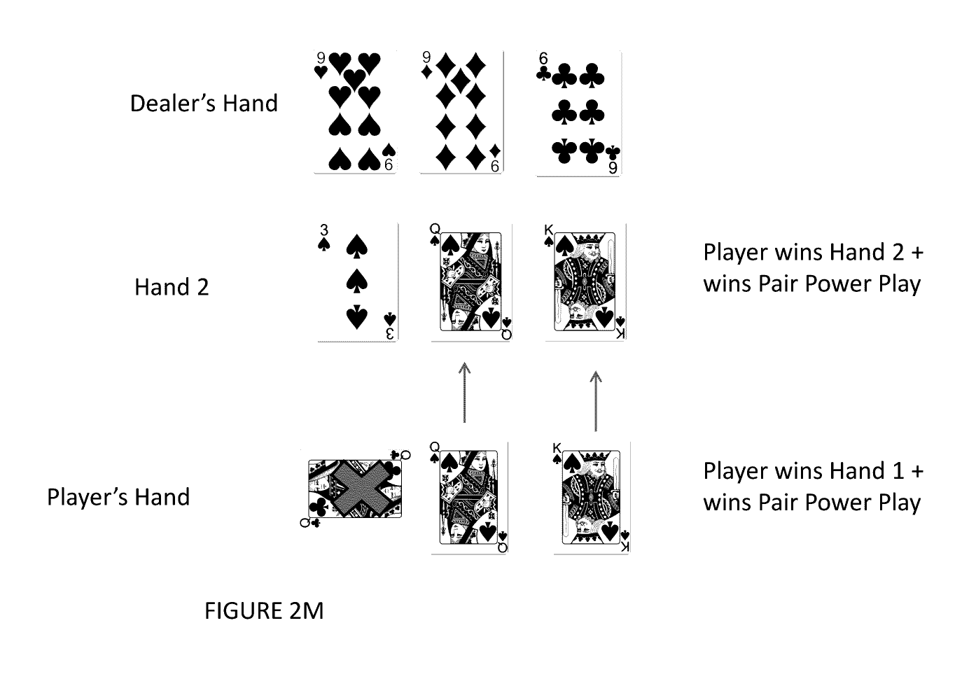

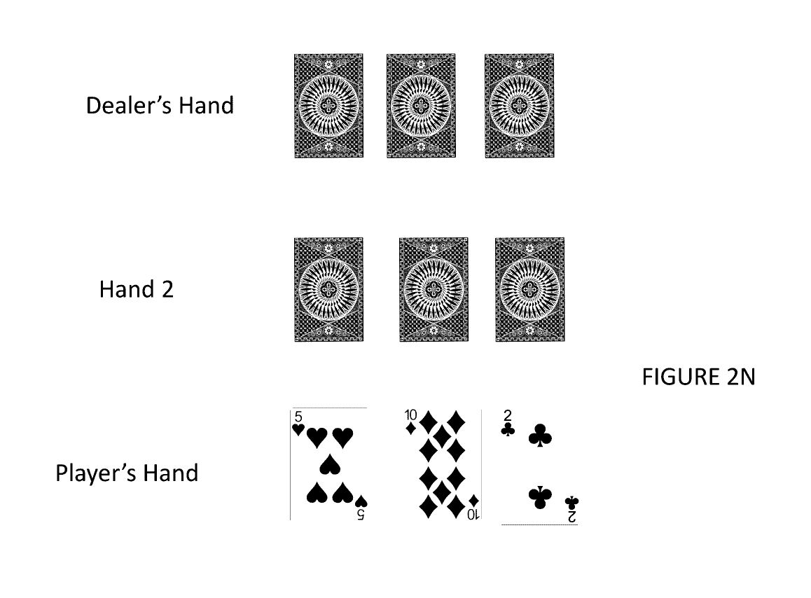

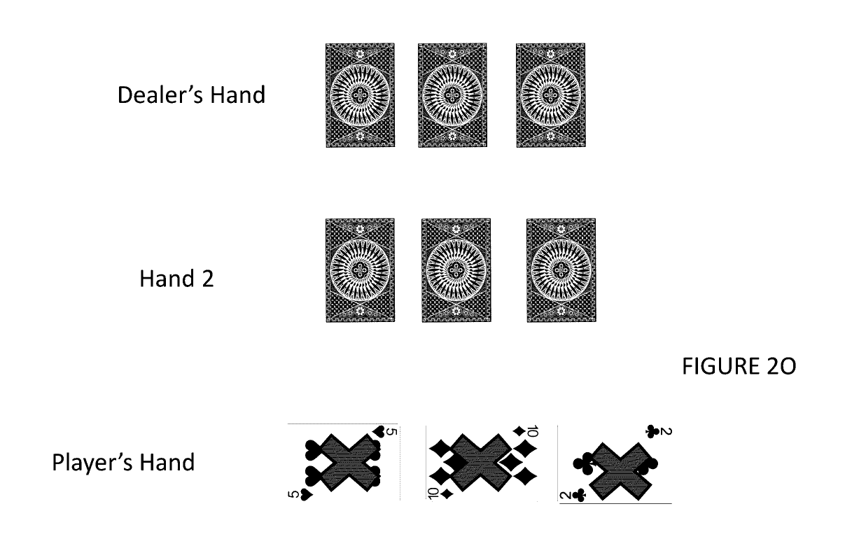

FIG. 2A shows a Double Deal (TM) player layout for a Three-Card Poker(TM) game variant.

FIG. 2B-FIG. 2G shows a sequence of player hand events in a single wagering event outcome.

FIG. 2H-FIG. 2M shows a sequence of player hand events in a second single wagering event outcome.

FIG. 2N-FIG. 2O shows a sequence of player hand events in a third single wagering event outcome in which no individual playing cards in a player first hand are moved into a second player hand for play.

The play strategy and card movements are well-defined and self-evident in the Figures.

The game technology may be played with any number of cards in each hand as previously described. The game is preferably played with a single standard deck of playing cards (52 cards, 13 ranks and 4 suits) although a joker may be added for game rule reasons, such as a wild card, zero value card, etc. MultiPlay Card option can be used in all single deck cards games. These games include (but are not limited to):

Casino War

Let It Ride™ poker

Double Down Stud

Three Card Poker

Four Card Poker

Mississippi Stud

Caribbean Stud® poker

Wild Hold 'em Fold 'em;

and the like.

What is claimed:

1. A method of playing a playing card wagering game against a paytable and a dealer position hand, the playing card game including steps of:
a) a player position receiving two distinct wagers at each of two ante positions at the player position;
b) providing two distinct hands of an equal number of random playing cards, one hand each at each of the two ante positions comprising a first hand and a second hand, the first hand being immediately viewable upon its being provided at the player position, and the second hand not being immediately viewable upon delivery and the first hand and second hand being received as distinct sets of the equal number of cards;
c) providing a dealer position hand of random playing cards having a number of random cards at least equal to the equal number of random playing cards in the first hand;
d) receiving a second wager at a second bet position at the first hand position to continue play of the playing card wagering game with the first hand, or ending play of the first hand by the dealer position collecting the wager at the ante position for the first hand;
e) absolutely indicating in a first hand in which play is to be continued which if any playing cards are to be replaced, while leaving all playing cards in the first hand exposed to view and leaving all cards in an ordered position at the player position;
f) revealing all playing cards in the second hand while each card in the second hand is in alignment with a specific playing card in the revealed first hand;
g) receiving a second wager at a second bet position at the second hand position to continue play of the playing card wagering game with the second hand, or ending play of the second hand by the dealer position collecting the wager at the ante position for the second hand;
h) revealing the playing cards of the dealer position hand;
i) reading final poker rank of the two player hands as follows:
A) the second hand rank is read as including all playing cards in the second hand according to standard poker rankings for the number of playing cards in the second hand;
B) the first hand rank is read by including only cards that have not been absolutely indicated as a card to be replaced, and then reading as a replacement card for each card indicated as replaced an aligned playing card from the second player hand, rank of the first hand according to standard poker rankings for the number of playing cards in the second hand; and
j) resolving all wagers at the first hand and the second hand by comparing ranks of the first hand and second hand against rank of the dealer hand and at least one of the first wager and the second wager for each of ranks of the first hand and the second hand against a paytable for poker hand ranks.

2. A method of playing a playing card wagering game against a paytable and a dealer position hand, the playing card game including steps comprising:
a) a player position receiving two distinct wagers at each of two ante positions at the player position;
b) providing two distinct hands of an equal number of random playing cards, one hand each at each of the two ante positions comprising a first hand and a second hand, the first hand being immediately viewable upon its being provided at the player position, and the second hand not being immediately viewable upon delivery and the first hand and second hand being received as distinct sets of the equal number of cards;
c) providing a dealer position hand of random playing cards having a number of random cards at least equal to the equal number of random playing cards in the first hand;
d) receiving a second wager at a second bet position at the first hand position to continue play of the playing card wagering game with the first hand, or ending play of the first hand by the dealer position collecting the wager at the ante position for the first hand;
e) absolutely indicating in a first hand in which play is to be continued which if any playing cards are to be transferred to the second hand to a parallel aligned position in the second hand, while leaving all playing cards in the first hand exposed to view and leaving all cards in an ordered position at the player position;
f) revealing all playing cards in the second hand while each card in the second hand is in alignment with a specific playing card in the revealed first hand;
g) receiving a second wager at a second bet position at the second hand position to continue play of the playing card wagering game with the second hand, or ending play of the second hand by the dealer position collecting the wager at the ante position for the second hand;
h) revealing the playing cards of the dealer position hand;
i) reading final poker rank of the two player hands as follows:
A) the first hand rank is read using all original playing cards dealt to the first hand, even is cards are indicated as being passed into the second hand;
B) the second hand rank is read by including cards that have been absolutely indicated as being transferred from the first hand into the second hand and the playing card(s) dealt into the second hand that parallel playing cards in the first hand that were absolutely indicated as not being transferred into the second hand from the first hand; and
resolving all wagers at the first hand and the second hand by comparing ranks of the first hand and second hand against rank of the dealer hand and at least one of the first wager and the second wager for each of ranks of the first hand and the second hand against a paytable for poker hand ranks.

3. A method of playing a playing card wagering game against a paytable and a dealer position hand, the playing card game including steps of:
a) a player position receiving at least two distinct wagers at each of two ante positions at the player position;
b) providing at least two distinct hands, one each at each of the at least two hands of an equal or different number of random playing cards, one hand each at each of the two ante positions comprising a first hand and a second hand, the first hand being immediately viewable upon its being provided at the player position, and the second hand not being immediately viewable upon delivery and the first hand and second hand being received as distinct sets of the equal or different number of cards;
c) providing a dealer position hand of random playing cards having a number of random cards at least equal to a largest number of playing cards in any player hand or an equal number of random playing cards in the first hand;
d) receiving a second wager at a second bet position at the first hand position to continue play of the playing card wagering game with the first hand, or ending play of the first hand by the dealer position collecting the wager at the ante position for the first hand;
e) absolutely indicating in a first hand in which play is to be continued which if any playing cards are to be replaced, while leaving all playing cards in the first hand exposed to view and leaving all cards in an ordered position at the player position;
f) revealing all playing cards in the second hand while each card in the second hand is in alignment with a specific playing card in the revealed first hand;
g) receiving a second wager at a second bet position at the second hand position to continue play of the playing card wagering game with the second hand, or ending play of the second hand by the dealer position collecting the wager at the ante position for the second hand;
h) revealing the playing cards of the dealer position hand;
i) reading final poker rank of the two player hands as follows:
C) the second hand rank is read as including all playing cards in the second hand according to standard poker rankings for the number of playing cards in the second hand;
D) the first hand rank is read by including only cards that have not been absolutely indicated as a card to be replaced, and then reading as a replacement card for each card indicated as replaced an aligned playing card from the second player hand, rank of the first hand according to standard poker rankings for the number of playing cards in the second hand; and
j) resolving all wagers at the first hand and the second hand by comparing ranks of the first hand and second hand against rank of the dealer hand and at least one of the first wager and the second wager for each of ranks of the first hand and the second hand against a paytable for poker hand ranks.

3. The method of claim 1 wherein the playing cards are virtual playing cards provided randomly by a random number generator in communication with a processor, and images of the virtual playing cards revealed are displayed on a video display system, and wagers are entered through player input controls in communication with the processor and resolution of wagers is performed by the the processor, with resolution of wagers including an accounting function through which player credits are displayed on the video display system after resolution of all wagers.

4. The method of claim 2 wherein the playing cards are virtual playing cards provided randomly by a random number generator in communication with a processor, and images of the virtual playing cards revealed are displayed on a video display system, and wagers are entered through player input controls in communication with the processor and resolution of wagers is performed by the processor, with resolution of wagers including an accounting function through which player credits are displayed on the video display system after resolution of all wagers.

5. The method of claim 3 wherein the playing cards are virtual playing cards provided randomly by a random number generator in communication with a processor, and images of the virtual playing cards revealed are displayed on a video display system, and wagers are entered through player input controls in communication with the processor and resolution of wagers is performed by the processor, with resolution of wagers including an accounting function through which player credits are displayed on the video display system after resolution of all wagers.

6. The method of claim 1 wherein the playing cards are physical playing cards that provide random cards to complete the hand.

7. The method of claim 2 wherein the playing cards are physical playing cards that provide random cards to complete the hand.

8. The method of claim 3 wherein the playing cards are physical playing cards that provide random cards to complete the hand.

9. The method of claim 7 wherein the two hands comprises three hands after three distinct wagers have been placed at the player position.

10. The method of claim 8 wherein the two hands comprises three hands after three distinct wagers have been placed at the player position.

11. The method of claim 9 wherein the two hands comprises three hands after three distinct wagers have been placed at the player position.

12. The method of claim 1 wherein a random playing cards are provided as randomized sets of playing cards provided from an electromechanical playing card randomization machine.

13. The method of claim 2 wherein a random playing cards are provided as randomized sets of playing cards provided from an electromechanical playing card randomization machine.

14. The method of claim 3 wherein a random playing cards are provided as randomized sets of playing cards provided from an electromechanical playing card randomization machine.

15. The method of claim 4 wherein a random playing cards are provided as randomized sets of playing cards provided from an electromechanical playing card randomization machine.

16. The method of claim 6 wherein a random playing cards are provided as randomized sets of playing cards provided from an electromechanical playing card randomization machine.

17. The method of claim 7 wherein a random playing cards are provided as randomized sets of playing cards provided from an electromechanical playing card randomization machine.
